(19) United States
(12) Patent Application Publication
(10) Pub. No.: US 2008/0098831 A1
(43) Pub. Date: May 1, 2008

(54) SEATING SURROGATE

(75) Inventors: Peter Didyk, Northville, MI (US); Bill A. Hammond, Linden, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/554,697

(22) Filed: Oct. 31, 2006

(51) Int. Cl. G01M 19/00

(52) U.S. Cl. 73/865.3

(57) ABSTRACT

A seating surrogate suitable for use in seat testing operations, such as but not limited to those associated with vehicle seat testing and non-vehicle seat testing. The surrogate may include a back form and a buttock form to mimic a human back and buttock. The forms may be operable connected to be simulate actual human interaction with a tested seat.

### BACKGROUND OF THE INVENTION

1. Field of the Invention

The present invention relates to seat surrogates of the type employed to facilitate seat testing operations.

2. Background Art

Seating surrogates are commonly employed in a number of industries to facilitate seat testing operations. The seat testing operations may relate to any number of operations aimed a simulating or otherwise approximating human interaction with a seated surface. One desire of the testing is to approximate a lifetime of human interaction with the seated surface through repeatedly interfacing the seating surrogate with the seat.

In the past, the seating surrogates generally comprised rigid structures have a back form and a buttock form. The back form generally being associated with a rigid simulation of a human back and the buttock form generally being associated with a rigid simulation of a human buttock/leg. The back and buttock forms are connected together to provide a L-shape seating surrogate. The L-shape is defined according to a fixed or a single axis hinged connection between the back and buttock forms such that there is no flexibility or flexibility in a single direction between the forms.

This limited flexibility tends to negatively influence the desired testing operations as the actual human connection between the back and buttock are not similarly fixed or limited to movement about a single-plane of movement. The bio-mechanics of the lower lumbar in a human allow a person to move in all three perspective planes. As seat testing is to replicate these motions a rigid form with a single hinged connection point does not allow for adequate replication of these movements. Furthermore, the current seating surrogate does not contain any flexible elements in its construction to simulate the actual deflection and freedom exhibited in the human spine.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a seating surrogate in accordance with one non-limiting aspect of the present invention;

FIG. 2 illustrates the spine joint in accordance with one non-limiting aspect of the present invention; and

FIG. 3 illustrates movement about all three axes of movement in accordance with one non-limiting aspect of the present invention.

### DETAILED DESCRIPTION OF THE PREFERRED EMBODIMENT(S)

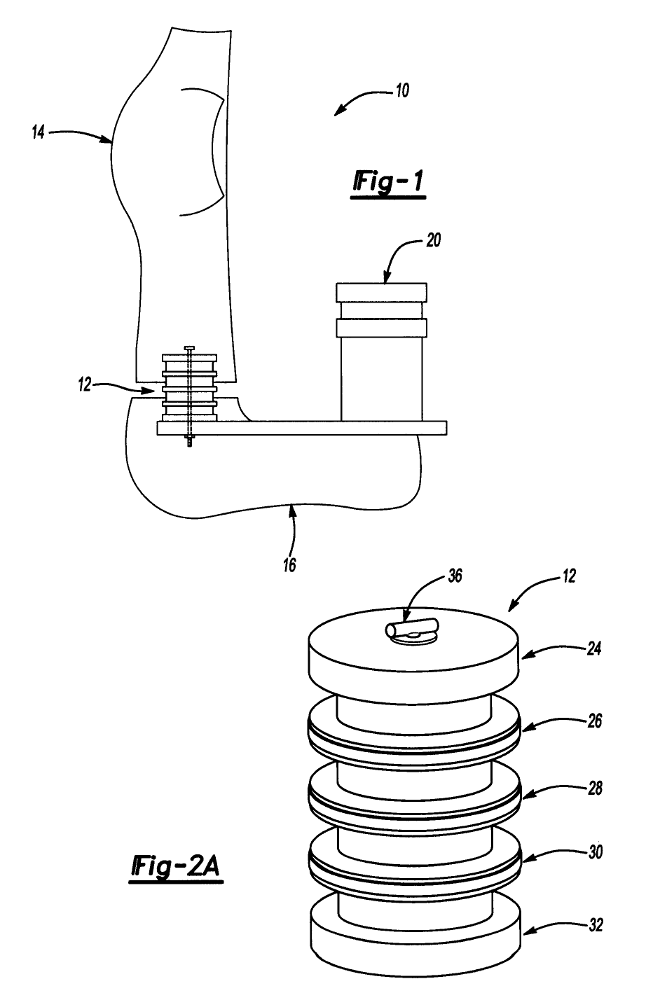

FIG. 1 illustrates a seating surrogate 10 in accordance with one non-limiting aspect of the present invention. The seating surrogate 10 may be configured to improve simulation of the human skeletal structure with the inclusion of a spine joint 12 between a back form 14 and buttock form 16. The spine joint 12 may be configured to permit movement in all planes in order to better simulate the interaction between a human back and buttock.

The present invention contemplates use of the seating surrogate 10 in testing and other operations associated with simulating or otherwise assessing human interaction with any type of seating surface, including but not limited to vehicle seats. Human interactions with various seated surfaces are often simulated via product life testing. These product life tests are used in various industries to replicate human interaction. Such industries can be found in but are not limited to: bio-mechanical fields such as automotive, rail, boat and air as well as biomedical fields such as wheelchair, gurney and hospital beds. In this manner, the present invention may be used across any number of industries to facilitate testing any number of seating parameters.

The seating surrogate 10 may be attached to a multi-axis robot (not shown) about a connection point 20. Once attached to the robot, the robot may be used to interface the seating surrogate 10 with a seat, as one having ordinary skill in the art will appreciate. The robot may position or arrange the seating surrogate 10 in any number of directions and with any amount of force. The robot may include a controller (not shown) or other feature to facilitate controlling the operations thereof.

The back form 14 may be configured to simulate a human back. The back form 14 may be desired to extend from a portion proximate a human hip and above. The back form 14 may comprise a rigid material of fixed construction such that it contacts the seat back without flexing or otherwise bending. Of course, the back form 14 need not necessarily comprise a such a rigid structure, depending on desired testing conditions. The rigid material, however, may be advantageous in prolong the usage lifetime of the seating surrogate and insuring adequate forces are applied to the seat back.

The buttock form 16 may be configured to simulate a human buttock. The buttock from 16 may correspond with an area proximate the human hip and below. The buttock form 16 may comprise a rigid material of fixed construction such that it contacts the seat back without flexing or otherwise bending. Of course, the buttock form need not necessarily comprise a such a rigid structure, depending on desired testing conditions. The rigid material, however, may be advantageous in prolonging the usage lifetime of the seating surrogate and insuring adequate forces are applied to the seat back.

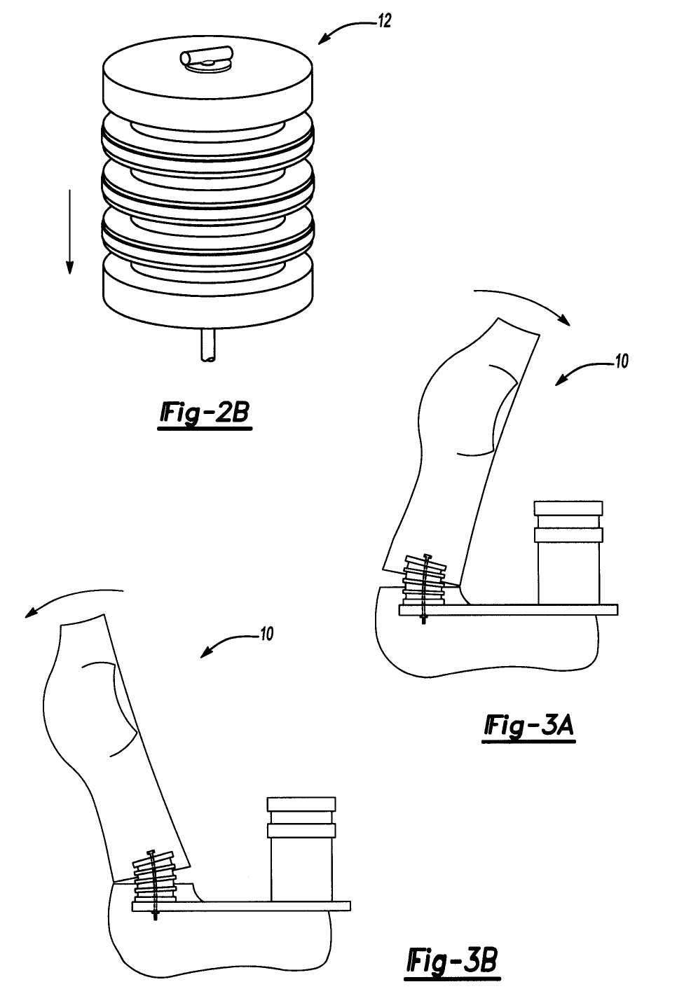

FIGS. 2a-b illustrate the spine joint 12 in accordance with one non-limiting aspect of the present invention. The spine join 12 may comprise multiple discs configured to simulate human vertebrae 24-32. The discs 24-32 may comprise a flexible rubber material or other material have properties sufficient to simulate movements associated with a human spine. The discs 24-32 may be coupled together with a tensioning member 36 so as to support the back form 14 in an upright position relative to the buttock form.

The tensioning member 36 may include a cable extending between top and bottom sides of the spine joint 12. The cable may be controllably tightened to control compression of the discs against each other. The disc compression may be selectively controlled and adjusted to control an active resistance of the spine joint 12. The active resistance generally corresponds with the resistance between the discs 24-32 that resist movement of the joint in all directions, i.e., about all three possible axes of movement.

This active resistance may be sufficient to maintain the back from 14 in an upright position relative to the buttock form 16, as shown in FIG. 1. The active resistance of the spine joint 12 is used to facilitate simulating movements associated with a human spine. The active resistance may be controlled or otherwise adjusted to resist movements associate with forces below a predefined threshold such that the back form 14 may be free to move in any direction at forces above the threshold. In this manner, the present invention is able to simulate movement of the human spine and replicate its biomechanical properties via back force/deflection, i.e., movement associated with three planes of motion.

The spine joint 12 of the present invention is advantageous over seating surrogates having fixed or single axis connections between the back form and buttock form. Moreover, the present invention is advantageous over seating surrogates having ball joints, universal joints, or other joints that permit movement about multiple axes but do so without providing active resistance. Such joints require additional features, supports, etc. in order to retain the back form in an upright position and to permit the movement of the same during testing.

The construction of the spine joint 12 is shown for explanatory purposes and without intending to limit the scope and contemplation of the present invention. The present invention fully contemplates the use of any number of other configurations for the spine joint 12 and is not intended to be limited to the foregoing.

For example, the spine joint 12 may comprising a flexible material of uniform or non-disc construction, the spine joint may include discs having different material properties (i.e., to induce non-linear active resistance, etc.), and/or the spine joint may include other constructions sufficient to permit movement of the back form 14 about multiple axes, such as but not limited to permitting simultaneous movement about at least two axes or other movement suitable for simulating movement actually associated with movements of a human spine.

FIG. 2a illustrates the spine joint 12 in an uncompressed state relative to the more compressed state illustrated in FIG. 2b. The transition between the different compression states, as noted above, may be advantageous in adjusting the flexure, rotation, bending, and other movements associated with the active resistance of the spine joint. In general, the spine joint 12 may be comprised of individual vertebrae 24-32 (of any material or construction) having properties associated with increasing the active resistance in response to increasing tension.

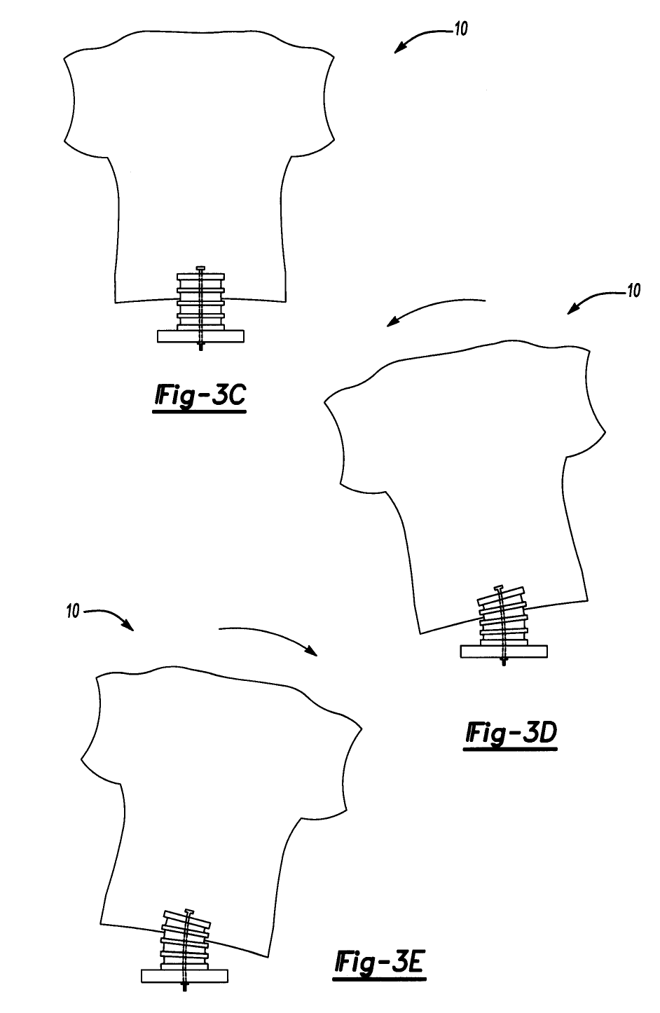

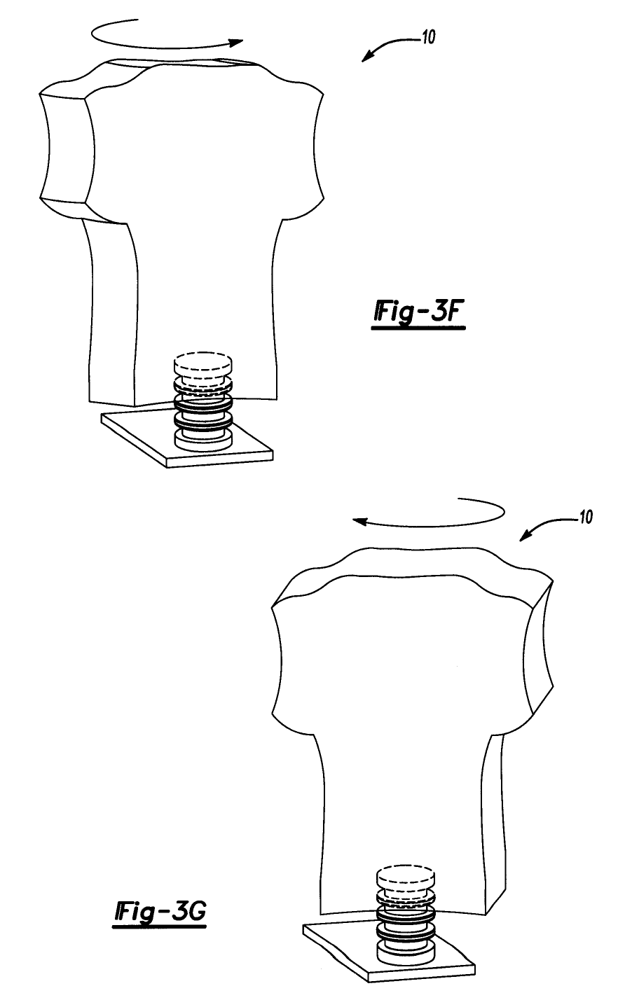

FIGS. 3a-g illustrate movement of the seating surrogate 10 about all three axes of movement in accordance with one non-limiting aspect of the present invention. The spine joint 12 is configured to simulate movement of an actual human spine such that the spine joint 12 is able to move in all directions, i.e. simultaneously about multiple axes. This includes twisting, tilting, rotating, flexing, etc. of the spine in any direction.

FIGS. 3a-b illustrates fore and after movement of the seating surrogate 10. FIGS. 3c-e illustrate lateral movement of the seating surrogate 10. FIGS. 3f-g illustrates twisting movement of the seating surrogate 10. Each of these illustrated movements are shown individually for exemplary purposes only. As noted above, the surrogate 10 may be move in one or more of these directions at the same time, in a commiserate with movement associated with a human spine. For example, the back form 14 may be displaced in the aft direction while simultaneously being twisted in a counter-clockwise direction, and optionally be tilted laterally.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A seating surrogate comprising:
a back form configured for simulating a human back form;
a buttock form configured for simulating a human buttock form; and
a spine joint connected between the back form and buttock form, the spine joint configured to simultaneously permit multiple axis movement between the back and buttock forms.

2. The seating surrogate of claim 1 wherein the spine joint permits movement between the back and buttock form about three axes such that movement in all directions is permitted.

3. The seating surrogate of claim 1 wherein the spine joint provides active resistance about each axis of movement.

4. The seating surrogate of claim 3 wherein the active resistance is sufficient to maintain the back form in an upright position relative to the buttock form in the absence of force being applied thereto.

5. The seating surrogate of claim 4 wherein the active resistance is sufficient to allow the back from to move relative to the buttock form if force applied thereto is above a predefined threshold.

6. The seating surrogate of claim 5 wherein the spine joint includes a tensioning member configured to facilitate selecting the predefined threshold associated with permitting movement between the back and buttock forms.

7. The seating surrogate of claim 1 wherein the spine joint includes a flexible material sufficient to provide active resistance about each axis of movement.

8. The seating surrogate of claim 7 further comprising a tensioning member configured to facilitate controlling the active resistance of the spine joint.

9. The seating surrogate of claim 8 wherein the tensioning member is configured to control the active resistance of the spine joint by controllably compressing the flexible material.

10. The seating surrogate of claim 7 wherein the flexible material is shaped to simulate a spine vertebrae.

11. The seating surrogate of claim 10 wherein the spine joint includes multiple spine vertebrae.

12. The seating surrogate of claim 1 wherein the spine joint is configured to stand the back form upright relative to the buttock form.

13. The seating surrogate of claim 1 wherein the back and buttock forms include a rigid material and the spine joint includes a flexible material such that the rigid forms interconnect with the flexible material to provide a three-piece assembly having multiple rigid portions and a flexible portion.

14. A seating surrogate comprising:
a back configured for simulating a human back;
a buttock configured for simulating a human buttock; and
a active resistance joint connected between the back form and buttock form, the joint configured to permit multiple axis movement between the back and buttock forms.

15. The seating surrogate of claim 14 wherein the joint includes a number of flexible discs configured to simulate movement associated with a human spine.

16. The seating surrogate of claim 15 further comprising a tensioning member configured to control an amount of active resistance of the join.

17. A seating surrogate comprising:
a back configured for simulating a human back;
a buttock configured for simulating a human buttock; and
a joint having multiple flexible discs configured to simulate movement associated with a human spine, the join connect the back form to the buttock such that the back is permitted to move about the buttock in order to simulate movement of the human spine.

18. The seating surrogate of claim 17 further comprising a tensioning member to control tensioning between the discs.

19. The seating surrogate of claim 18 wherein the tensioning between the discs controls an active resistance associated with movement of joint.

20. The seating surrogate of claim 17 wherein the joint simulates movement associated with a lower spine portion of a 95% male.
